(19) United States
(12) Patent Application Publication
(10) Pub. No.: US 2011/0317744 A1
(43) Pub. Date: Dec. 29, 2011

(54) SYSTEM AND METHOD FOR SPREAD SPECTRUM ACOUSTIC COMMUNICATION

(76) Inventor: Alan ERICKSON, Bozeman, MT (US)

(21) Appl. No.: 12/825,849

(22) Filed: Jun. 29, 2010

(51) Int. Cl. H04B 1/707

(52) U.S. Cl. 375/140; 375/E01.002

(57) ABSTRACT

Systems and methods for communicating with acoustic signals and, more particularly, systems and methods for communicating using direct-sequence spread spectrum acoustic waves generated by non-impulsive sources. A data signal is modulated by a pseudorandom noise signal and the modulated spread spectrum signal is coupled to a transmission medium for propagation of an acoustic wave through the medium. Acoustic signals are received from the medium and are possessed to obtain a transmitted data signal.

### BACKGROUND OF THE INVENTION

1. Field of the Invention

The present invention relates to systems and methods for communication with acoustic signals. More particularly, aspects of the present invention relate to systems and methods for transmitting data by generating spread spectrum acoustic waves.

2. Description of the Background

Conventional communication technologies provide information links between remote locations using, e.g., electromagnetic waves (e.g., radio waves, microwaves, optical waves, etc.). The effectiveness of different types of electromagnetic communication can vary by application, e.g., depending on the medium through which the electromagnetic waves must propagate. For example, in mining and other subterranean activities, communication is primarily accomplished by low-frequency radio waves. This typically requires laying out wire antennas along mine shafts and tunnels. Deploying the antennae can be labor and resource intensive, and furthermore the antennae themselves, which can carry an electrical current, can pose an additional safety hazard in already dangerous environments. In other applications, e.g., in applications where secrecy is desirable, any form of electromagnetic communication may be too readily detectable by third parties with suitable equipment.

Other conventional communication technologies provide information links between remote locations using, e.g., acoustic waves (e.g., sound waves, sonar, seismic waves, etc.). As with electromagnetic waves, the effectiveness of conventional acoustic communication systems can be highly dependent on the medium through which the acoustic waves propagate. Furthermore, acoustic communication systems must typically generate acoustic waves of large amplitude to overcome attenuation. This attenuation may be caused by several sources, e.g., scattering caused by inhomogeneous ground layers, the impedance of the earth or water, the natural low-pass filtering of the medium through which the acoustic waves propagate, etc. Therefore conventional acoustic communication systems typically require large energy inputs, which can be expensive and invasive.

Furthermore, large amplitude acoustic waves are easily detectable by third parties and as such, conventional acoustic communication systems are not suitable for applications in which secrecy is desired. In many circumstances, conventional acoustic communication systems are too intrusive or destructive. For example, conventional acoustic communication systems may be a nuisance or hazard in heavily populated or crowded areas, urban environments, wildlife refuges, cave systems and other protected spaces, potentially fragile environments such as unstable mineshafts, etc.

Still further, acoustic communication systems are highly susceptible to interference from environmental sources of acoustic waves (e.g., road traffic, explosions, mining, drilling, natural seismic events, etc.).

It is therefore an object of the present invention to provide an improved communication system and method that overcomes the aforementioned challenges and drawbacks.

### BRIEF SUMMARY OF THE INVENTION

In some aspects, the present invention provides a system and methods for communicating using spread spectrum acoustic signals by generating a pseudorandom noise signal; modulating an input signal by said pseudorandom noise signal to generate a direct-sequence spread spectrum (“DSSS”) signal; physically coupling the DSSS signal to a transmission medium to generate a spread spectrum acoustic wave; receiving the spread spectrum acoustic wave at a remote location; and processing the received signals to recover the original data signal. The system and methods allow one to communicate via acoustic waves propagating through materials such as the ground, water tables, bedrock, outcrops, and buildings.

The present invention makes use of spread-spectrum linear modulation of a transmitter, thus moving some of the burden of increasing signal-to-noise ratio (SNR) from the power of the transmitter to signal processing in the receiver, allowing much lower energy densities to be utilized. This allows one to use substantially less powerful energy sources that are less detectable by third parties, and are less intrusive than the conventionally used acoustic communication systems, all while being more robust against interference or jamming. Additional aspects of spread-spectrum acoustic transmissions are described in U.S. patent application Ser. No. 12/566,132, filed Sep. 24, 2009, the entire contents of which are incorporated herein by reference. In some embodiments, the present invention can be used by forward military units to facilitate secure communication to units in the rear that is nearly undetectable and unjammable.

Further, in some aspects, the present invention provides a system and method for acoustic communication that enables control over many of the signal parameters, such as the spectral distribution of energy. For example, one can select appropriate spectral distributions of the spread spectrum acoustic waves to reduce the impact of any ambient acoustic noise.

In some aspects, the present invention supports the simultaneous transmission of multiple data signals using code-division multiplexing of acoustic signals (e.g., using CDMA techniques understood by those having skill in the art). Multiple transmitters and receivers can be networked to provide extended and redundant paths of communication. In some embodiments, the present invention provides a communications network for ship-to-shore and shore-to-ship communication systems at least wherever efficient coupling exists between the water and the ground (e.g., where bedrock or a rock formation projects into or is abutted by the water), or where the water table may be used as a communication channel.

The present invention provides robust acoustic communications in protected spaces, potentially fragile environments, and areas where communications must remain unobtrusive. One may use acoustic communication systems according to aspects of the invention in human-built infrastructure (e.g. building foundations, bridges, roads, etc.) without damage. Provision for soundings (e.g. transmit and receive attachment points) may be built into the structures or later installed without requiring extensive materials or labor.

According to an aspect of the invention, a method is provided for communicating using acoustic signals. The method may include steps of: generating a pseudorandom noise signal; modulating an input signal by the pseudorandom noise signal to generate a DSSS signal; and generating in a transmission medium an acoustic wave corresponding to the DSSS signal.

According to another aspect of the invention, a method is provided for communicating using acoustic signals. The method may include steps of: receiving an acoustic signal from a transmission medium; obtaining a pseudorandom noise signal; and demodulating the acoustic signal by the pseudorandom noise signal to recover the data signal.

According to a further aspect of the invention, a system is provided for communicating using acoustic signals. The system may include: a noise generator configured to generate a pseudorandom noise signal; a signal modulator configured to modulate an input signal by the pseudorandom noise signal in order to generate a DSSS signal; a transmit transducer configured to receive the DSSS signal, mechanically couple the DSSS signal to a transmission medium, and generate in the transmission medium an acoustic wave corresponding to the DSSS signal; a receive transducer configured to receive the acoustic signal from the transmission medium and convert the acoustic signal to electronic signals; and a signal demodulator configured to receive the electronic signal and demodulate it by the pseudorandom noise signal, thereby obtaining the data signal.

According to an aspect of the invention, a computer program product is provided for communicating using acoustic signals. The computer program product may include digital storage media and a set of machine readable instructions stored on said digital storage media. The machine readable instructions may include instructions executable by a computer to: generate a pseudorandom noise signal; modulate an input signal by the pseudorandom noise signal to generate a DSSS signal; and transmit the DSSS signal to a transmit transducer mechanically coupled to a transmission medium.

According to another aspect of the invention, a computer program product is provided for communicating using acoustic signals. The computer program product may include digital storage media and a set of machine readable instructions stored on said digital storage media. The machine readable instructions may include instructions executable by a computer to: receive an acoustic signal from a receive transducer that is mechanically coupled to a transmission medium; obtain a pseudorandom noise signal; and demodulate the acoustic signal by the pseudorandom noise signal in order to obtaining a data signal.

The above and other aspects and features of the present invention, as well as the structure and application of various embodiments of the present invention, are described below with reference to the accompanying drawings.

### BRIEF DESCRIPTION OF THE DRAWINGS

The accompanying drawings, which are incorporated herein and form part of the specification, illustrate various embodiments of the present invention and, together with the description, further serve to explain the principles of the invention and to enable a person skilled in the pertinent art to make and use the invention. In the drawings, like reference numbers indicate identical or functionally similar elements.

A more complete appreciation of the invention and the attendant advantages thereof will be readily obtained as the same becomes better understood by reference to the following detailed description when considered with the accompanying drawings wherein:

FIG. 1 is a functional block diagram of a system for performing communication using acoustic signals according to aspects of the present invention.

FIG. 2 is a functional block diagram of a system for performing communication using acoustic signals according to aspects of the present invention.

FIG. 3 is a functional block diagram of a system for performing communication using acoustic signals according to aspects of the present invention.

FIG. 4 is a functional block diagram of a system for performing communication using acoustic signals according to aspects of the present invention.

FIG. 5A is a flow chart illustrating a process for performing communication using acoustic signals according to aspects of the present invention.

FIG. 5B is a flow chart illustrating a process for performing communication using acoustic signals according to aspects of the present invention.

FIG. 6 is a functional block diagram of a system for performing communication using acoustic signals according to aspects of the present invention.

FIG. 7A is a functional block diagram of a system for performing communication using acoustic signals according to aspects of the present invention.

FIG. 7B is a functional block diagram of a system for performing communication using acoustic signals according to aspects of the present invention.

FIG. 8A is an illustrative data signal for a system for performing communication using acoustic signals according to an embodiment of the present invention.

FIG. 8B is an illustrative pseudorandom noise signal for a system for performing communication using acoustic signals according to an embodiment of the present invention.

FIG. 8C is an illustrative output of performing an exclusive-nor operation between a data signal and a pseudorandom noise signal for a system for performing communication using acoustic signals according to an embodiment of the present invention.

FIG. 8D is an illustrative carrier signal modulated using binary phase-shift keying modulation for a system for performing communication using acoustic signals according to an embodiment of the present invention.

FIG. 8E is an illustrative acoustic signal acquired by a system for performing communication using acoustic signals according to an embodiment of the present invention.

FIG. 8F is an illustrative recovered spread signal acquired by a system for performing communication using acoustic signals according to an embodiment of the present invention.

FIG. 8G is an illustrative preliminary recovered data signal generated by a system for performing communication using acoustic signals according to an embodiment of the present invention.

FIG. 8H is an illustrative recovered data signal generated by a system for performing communication using acoustic signals according to an embodiment of the present invention.

### DETAILED DESCRIPTION OF THE PREFERRED EMBODIMENTS

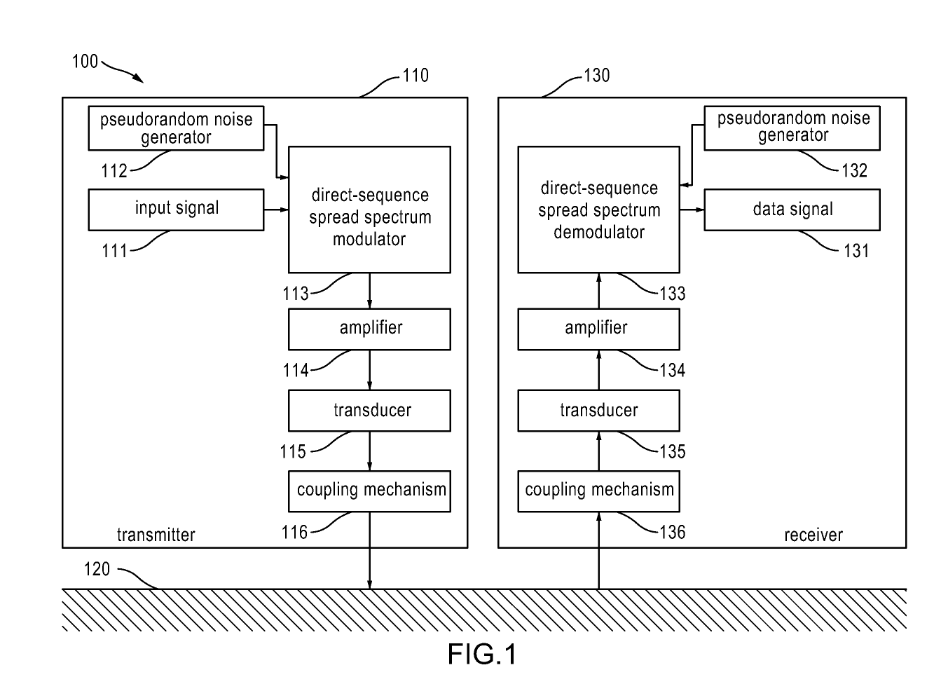

FIG. 1 illustrates a system 100 for performing communication using acoustic signals according to aspects of the present invention. As illustrated in FIG. 1, the system 100 may include a transmitter 110 and a receiver 130. The transmitter 110 may include a pseudorandom noise (“PRN”) generator 112 to generate a PRN signal, a direct-sequence spread spectrum (“DSSS”) modulator 113 for modulating an input signal 111 by the PRN signal from the PRN generator 112 to generate a DSSS signal, an amplifier 114 for increasing the power of the DSSS signal, a transmit transducer 115 for converting the DSSS signal to mechanical motion, and a coupling mechanism 116 for coupling the mechanical motion to the transmission medium 120 (e.g., the ground, water, bedrock, buildings, etc.).

In some aspects of the invention, the pseudorandom noise generator 112 may generate a PRN signal comprising a pseudorandom sequence of binary digits. In some embodiments, the pseudorandom noise generator 112 may be an application specific integrated circuit (“ASIC”), field-programmable gate array (“FPGA”), a digital signal processor (“DSP”), an assembly of discrete logical elements (e.g., NAND gates, XOR gates, etc.), or a general purpose microprocessor configured to execute software instructions stored in a computer readable memory. Pursuant to one embodiment of the invention, a commercially available personal computer (e.g., a Dell Latitude D620) programmed with software (e.g., commercially available software such as MathWorks™ MATLAB®, Parametric Technology Corporation (“PTC®”) Mathcad®, etc., or custom software written in C, C++, Java, etc. by one having ordinary skill in the art) to generate a suitable PRN sequence may be used to generate the spreading sequence.

In some preferred embodiments, the PRN may be chosen to have several properties, which can be summarized as: (a) its autocorrelation is very low, i.e., no part of the PRN signal closely resembles any other part; (b) its bandwidth is high compared to that of the data signal 111; and (c) if a plurality of signals are to be used within the same receiver range, the cross correlation between the plurality of PRN sequences should be low to prevent interference. Pursuant to one embodiment of the present invention, a software-based XOR-feedback shift register may be used to provide maximum-length sequences, e.g., of length on the order of 10¹² bits. Other sequence types could include Kasami codes, Gold codes, chaotic sequences generated by means known to those of skill in the art, and natural noise such as that from thermal sources. In some embodiments, Gold codes may be expedient for multiple communication channels due to Gold codes' low and well specified cross correlation and ease of generation. Pursuant to a further embodiment, the spreading signal may be a recorded signal, seismic or otherwise, from natural or man-made sources, including thermal shot noise, atmospheric, tectonic, ambient seismic, traffic, mining, excavating, drilling, littoral, river, or animal noise.

The DSSS modulator 113 may be configured to receive the input signal 111 and perform DSSS modulation using a PRN binary sequence from the PRN generator 112. In some embodiments, the DSSS modulator 113 may be an ASIC, an FPGA, a DSP, an assembly of discrete logical elements, or a general purpose microprocessor configured to execute software instructions stored in a computer readable memory. Pursuant to one embodiment of the invention, a commercially available personal computer (e.g., a Dell Latitude D620) programmed with conventional signal processing software (e.g., commercially available software such as MathWorks™ MATLAB®, PTC® Mathcad®, etc.) may be used to perform the DSSS modulation.

In DSSS, a data signal may be modulated by pseudorandom noise (PRN) or another bandwidth-spreading signal. As used herein, modulation may comprise any form of modulation that is suitable for transmission through the transmission medium 120 (e.g., amplitude modulation, frequency modulation, phase modulation, etc.) In some embodiments, binary phase-shift keying (“BPSK”) is used with coherent modulation. In some embodiments, quadrature amplitude modulation (“QAM”) can be used to increase a data rate. The use of DSSS and related signals provides acoustic communication that is less detectable by third parties (e.g., eavesdroppers, those engaged in illicit activity, etc.) and also less susceptible to jamming.

The amplifier 114 may be configured to receive an input signal (e.g., from the DSSS modulator 113) and output a corresponding amplified signal sufficient to drive the transmit transducer 115. Pursuant to one embodiment of the invention, a commercial amplifier (e.g., an AudioSource Amp5.3, a commercially available amplifier capable of delivering 250 W into 4Ω over a range of 20 Hz to 20 kHz) may be used. In other embodiments, other amplifiers having sufficient bandwidth characteristics and electrical properties suitable to drive the transducer according to the continuous spread spectrum signal may be used. In some embodiments where the transmission medium 120 is, for example, the ground, amplifiers having bandwidth range between at least 0.1 Hz to 1,000 Hz may be used.

The transducer 115 can be any device that converts the spread spectrum signal to mechanical motion at power levels sufficient to communicate with a receiver 130. In some embodiments, the transducer 115 may use electromagnetic, magnetofluidic, hydraulic, piezoelectric, pneumatic, torsional, or other mechanisms actuated by an electrical signal. Pursuant to one embodiment of the invention, an electromagnetic solenoid (e.g., a Clark Synthesis TST429 Platinum Transducer) is utilized that uses electromagnetic coils to react the mass of a permanent magnet against the coupling mechanism 116. A current proportional to the input signal runs through the coils and applies a force to the mass, and thus to a housing of the transducer 115. In some embodiments where the transmission medium 120 is, for example, the ground, transducers having a bandwidth range between at least 0.1 Hz to 1,000 Hz may be used. In other embodiments, any transducer suitable for coupling with the transmission medium 120 and delivering a signal with sufficient power for detection may be used.

In other embodiments, the transmit transducer 115 may be a pneumatic transducer that converts the DSSS signal into air pressure, which can be used to move the coupling mechanism 116 with a force corresponding to the signal for transmission. Pursuant to another embodiment, the transmit transducer 115 can be a hydraulic transducer that converts the DSSS signal into fluid pressure, which can then be used to move the coupling mechanism 116 with a force corresponding to the signal for transmission. In yet another embodiment, the transmit transducer 115 can be a piezoelectric transducer that converts the DSSS signal to mechanical force, which can then be used to move the coupling mechanism 115 with the force corresponding to the signal for transmission. In yet another embodiment, the transmit transducer 115 can be a magnetofluidic or electroheological transducer that converts the DSSS signal into fluid pressure, which can then be coupled to the medium 120 by the coupling mechanism 116 to provide a force that corresponds to the signal for transmission.

The coupling mechanism 116 may be implemented in a number of different ways, such as embedding the transducer 115 in the transmission medium 120, attaching the transducer 115 to buried or exposed rock formations, buried spikes, bolts, or other penetrative coupling means, or the use of a weight to provide a coupling bias. Pursuant to one embodiment of the invention, the transducer 115 is attached to the top of a metal spike, the other end of which is driven into the transmission medium 120 to provide coupling via friction between the spike and the transmission medium 120. Where the transmission medium 120 is water or another liquid, coupling can occur from a ship or a towed device, or from some other device that is floating in the liquid.

Coupling of the transducer 115 to the transmission medium 120 results in the launching of an acoustic wave into the transmission medium 120. The acoustic waves may be comprised of surface- and subsurface-propagated acoustic signals that have undergone reflection and refraction, air-propagated signals, and environmental and system noise. Signals of interest reaching to the receiver 130 consist of time-shifted versions of the transmitted DSSS signal, whereby the time shift is dependent on the reflection and refraction caused by subsurface features.

After the thus introduced acoustic wave undergoes changes during propagation through the transmission medium 120, the signal is received by the receiver 130. In some embodiments, the normal move out acoustic wave (i.e., the acoustic wave propagating along the surface of the transmission medium) is received by the receiver 130. In other embodiments, the received acoustic signal can be taken from other echoing acoustic waves (e.g., a reflection from a water table).

As illustrated in FIG. 1, in some embodiments the receiver 130 may comprise a receive transducer 135 that is coupled to the medium 120 by a coupling mechanism 136. The receiver 130 may also include a power amplifier 134 for amplifying the received signal, a DSSS demodulator 133 for demodulating the received signal, and PRN generator 132 for generating a PRN that is matched to the transmit sequence generated in the transmitter 110. The output from the DSSS demodulator 133 is the data signal 131, corresponds to the input signal 111.

The receive transducer 135 can be any device that converts the received signal to a corresponding electrical signal. Pursuant to one embodiment of the invention, a commercially-available geophone (e.g., a GeoSpace Technologies GS-20DH geophone) may be used. The geophone may be comprised of a coil of wires, suspended on a spring, around a permanent magnet fixed to the housing. The housing may be coupled to the ground via the coupling mechanism 136 (e.g., a spike that is driven into the ground). As the ground moves in response to the acoustic signals, the coil generates an electrical signal. Other transducers include piezoelectric materials, micromachined solid-state accelerometers, laser motion detectors, and other position, velocity or acceleration sensors.

The amplifier 134 may be may be configured to receive an electrical signal (e.g., from the receive transducer 135) and output a corresponding amplified signal sufficient for the DSSS demodulator 133 to produce reliable data. In some embodiments, the amplifier 134 may be any amplifier suitable to receive the transmitted DSSS signal without aliasing. In other embodiments, the amplifier 134 may be selected with characteristics suitable to receive the transmitted DSSS signal, as well as any ambient seismic noise or other expected sources of acoustic data, without aliasing. Furthermore, the signal received from the receive transducer 135 may be filtered (e.g., low-pass filtered or other band pass filtered, etc.) to have characteristics suitable for the amplifier 134.

The DSSS demodulator 133 may be configured to receive the amplified received signal and demodulate the signal using the pseudorandom noise provided by the PRN generator 132 and corresponding to the PRN generated by the PRN generator 112 in the transmitter 110. In some embodiments, the DSSS demodulator 133 may be an ASIC, an FPGA, a DSP, or a general purpose microprocessor configured to execute software instructions stored in a computer readable memory. Pursuant to one embodiment of the invention, a commercially available personal computer (e.g., a Dell Latitude D620) programmed with conventional signal processing software (e.g., commercially available software such as MathWorks™ MATLAB®, PTC® Mathcad®, Halliburton ProMAX®, etc.) may be process the received signal.

In some embodiments, the received signals may be transferred to a processing computer by standard means. Pursuant to one embodiment of the invention, a commercially available data acquisition unit (e.g., an IOTech Personal DAQ 3001) may be used to transfer the received signals from the receive transducer 124 or the amplifier 123 to a personal computer via a Universal Serial Bus (USB) interface.

In some embodiments, the components described above may be powered by a portable power device. Pursuant to one embodiment of the invention, a commercially available power inverter (e.g., a Black and Decker PI750B 750 W power inverter) may be used in conjunction with, e.g., a standard car battery.

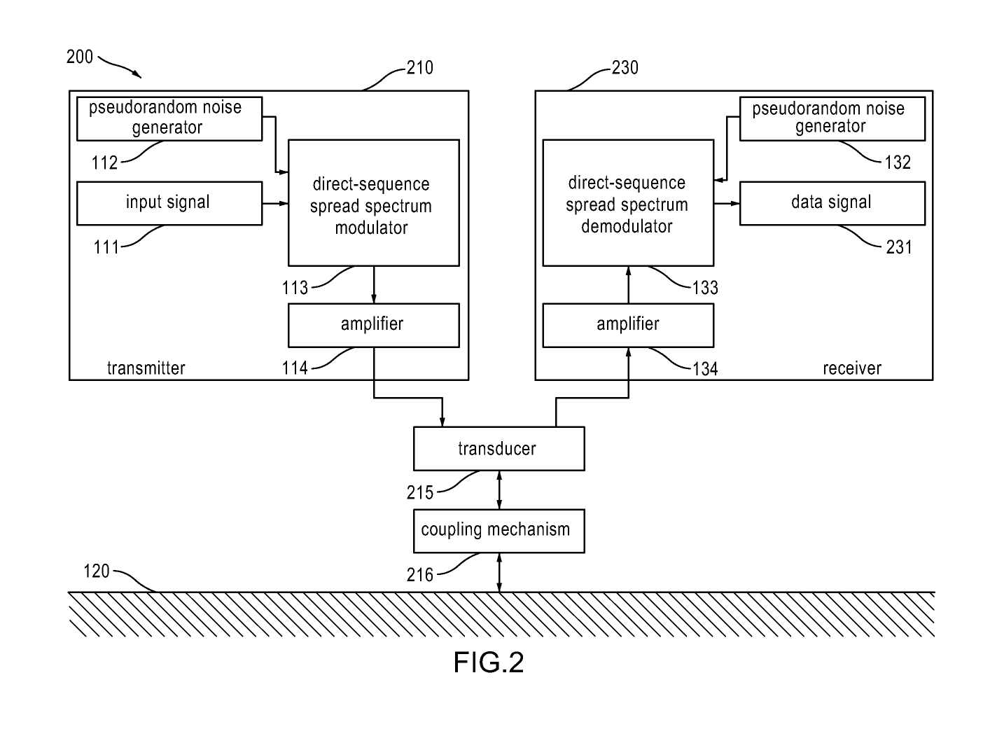

FIG. 1 illustrates a transmitter 110 and a receiver 130 that are separate devices. FIG. 2 illustrates a system 200 for performing duplex communication using acoustic signals according to aspects of the present invention. As illustrated in FIG. 2, a transmitter 210 and a receiver 230 can make simultaneous use of the same transducer 215 and coupling mechanism 216. That is, the system 200 can transmit an input signal 111 modulated by a first PRN sequence generated by the PRN generator 112, and simultaneously receive a separate data signal 231 modulated by a second PRN sequence. DSSS signals are amplified and applied to the shared transducer 215 in such a way as to permit signals created by the transducer 215 to be measured by the same transducer 215. Pursuant to one embodiment, a resistive impedance is used in series with an electromagnetic transducer to allow voltages induced by return signals to be measured. In some embodiments, to the transmitted signal must be selected to avoid saturating the transducer 215 with the transmit signal, and the amplifier 134 of the receiver 230 must have wide enough dynamic range to measure the small-amplitude return signal summed with the large-amplitude transmit signal. In this embodiment, a single transducer 215 and coupling mechanism 216 can be used to provide duplex communication (i.e., both transmitting and receiving) according to aspects of the invention.

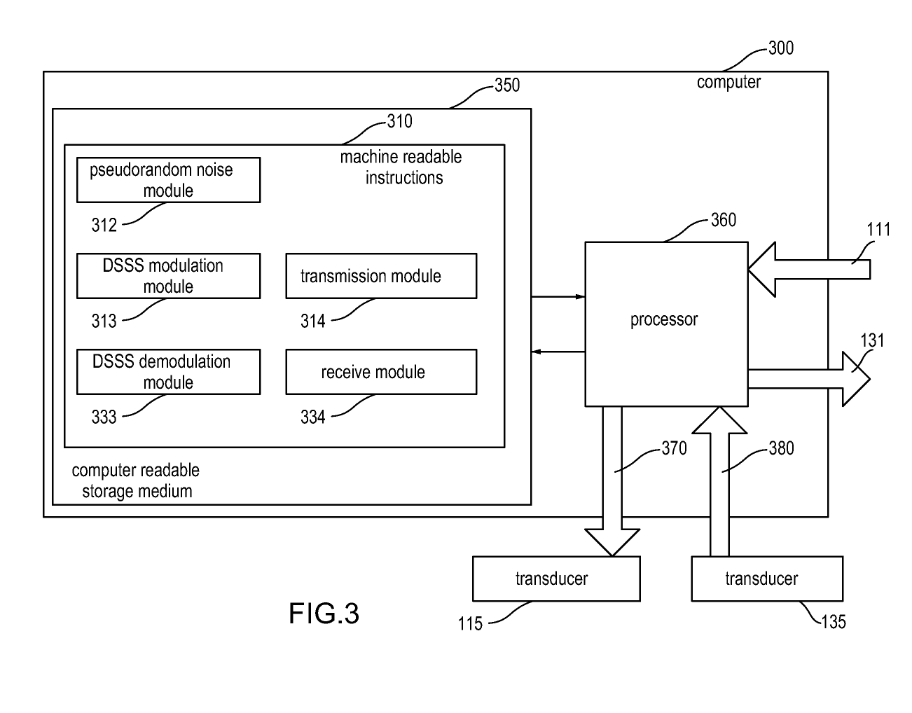

FIG. 3 illustrates a computer 300 including a computer program product for performing communication using acoustic signals according to aspects of the present invention. As shown in FIG. 3, machine readable instructions 310 may be stored in a computer readable storage medium 350 (e.g., a random access memory (“RAM”), an electrically erasable programmable read only memory (“EEPROM”), a flash memory, an optical disk, a magnetic disk, etc.). The machine readable instructions 310 may be accessed and executable by a processor 360 to transmit data via an output component 370 (e.g., a USB interface) and receive data via an input component 380 (e.g., a USB interface). The machine readable instructions 310 may include a pseudorandom noise module 312 for generating pseudorandom noise, a DSSS modulation module 313 for modulating an input signal 111 by the pseudorandom noise to generate a DSSS signal, and a transmission module 314 for transmitting the DSSS signal to a transducer 115 (e.g., via the USB interface 370). In some embodiments, the machine readable instructions 310 may include a receive module 334 for receiving signals from a transducer 135 (e.g., via the USB interface 380), and a DSSS demodulator 333 for demodulating a received signal based on pseudorandom noise generated by the pseudorandom noise module 312. Pursuant to some embodiments, the machine readable instructions 310 may include modules for transmitting and receiving to provide for duplex communication. Furthermore, pursuant to some embodiments the computer readable instructions may comprise a plurality of one or more of the modules for simultaneously processing one or more signals.

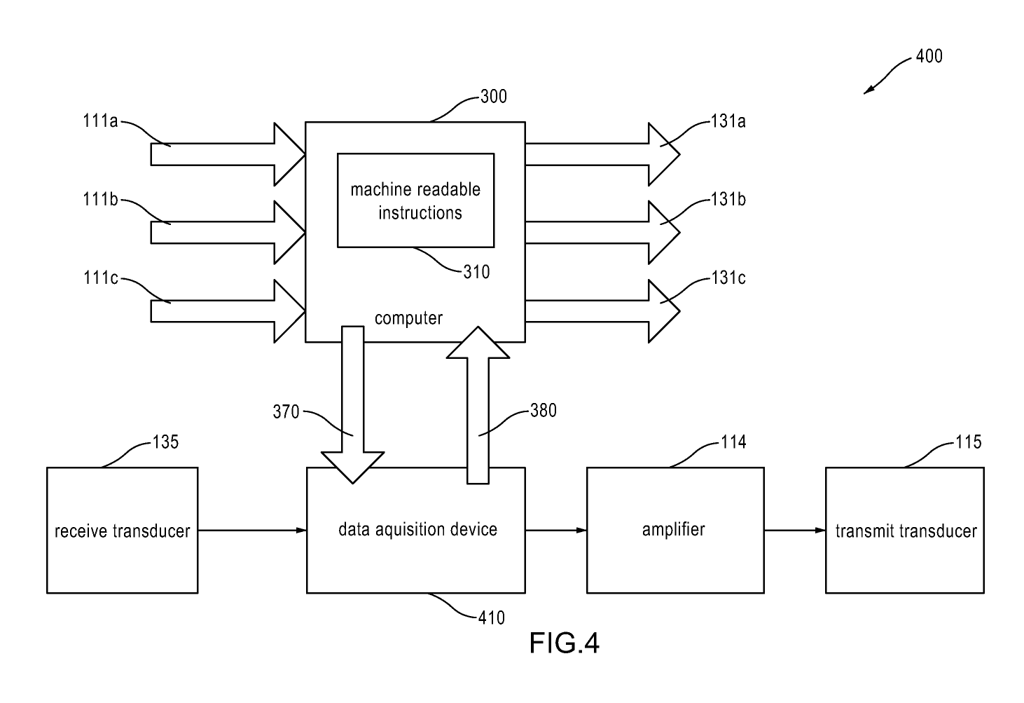

FIG. 4 illustrates a system 400 for performing communication using acoustic signals including a computer 300 according to some embodiments of the present invention. As shown in FIG. 4, the computer 300 may communicate with a data acquisition device 410 via the input and output components 370, 380. The data acquisition device 410 may be configured to receive continuous spread spectrum signals from the computer 300 and transmit the continuous spread spectrum signal to the amplifier 114. The data acquisition device may be further configured to receive signals from one or more receive transducers 135 and transmit the received data to the computer 300 for signal processing. Pursuant to one embodiment of the invention, the data acquisition device 410 may be a commercially available data acquisition unit.

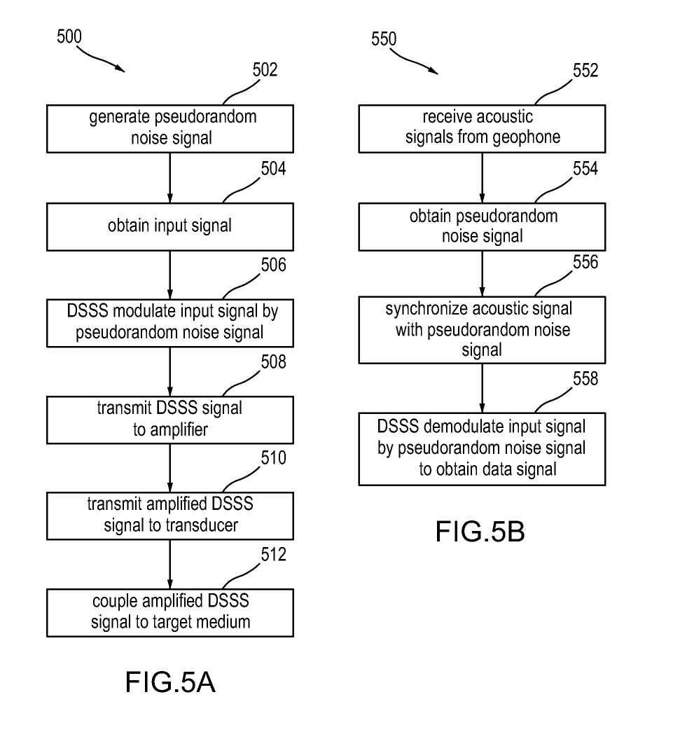

FIGS. 5A and 5B are flow charts illustrating, respectively, a process 500 for transmitting using acoustic signals according to aspects of the present invention and a process 550 for receiving and processing acoustic signals according to aspects of the present invention. In some embodiments, one or more of the steps in the processes 500 or 550 may be performed pursuant to software stored in a computer readable medium and one or more digital processors. In other embodiments, all or part of the processes 500 or 550 may be encoded into special purpose hardware (e.g., one or more FPGAs or application specific integrated circuits ASICs).

The process 500 for transmitting a DSSS acoustic signal according to some embodiments of the present invention may begin at step 502 when the pseudorandom noise generator 112 generates the pseudorandom noise signal.

At step 504, the transmitter 110 receives the input signal 111.

At step 506, the DSSS modulator uses the pseudorandom noise to modulate the input signal 111 and may apply further filtering (e.g., filtering specified by the user based on characteristics of the intended transmission medium 120).

At step 508, the DSSS modulator sends the DSSS signal to the amplifier 114. The amplifier 114 amplifies the spread spectrum signal as required and sends the spread spectrum signal to the transducer 115 (step 510).

At step 512, the transducer 115 transmits the DSSS signal, via the coupling mechanism 116, into the target medium 120.

The process 550 for receiving and processing return signals generated by a continuous spread spectrum sounding signal according to some embodiments of the present invention may begin at step 552 when a receiver 130 receives an acoustic signal from the transmission medium 120 via a coupling mechanism 136 and receive transducer 135 (e.g., a geophone).

At step 554, the receiver 130 obtains pseudorandom noise corresponding to the pseudorandom noise that was used to modulate the input signal. In some embodiments, the pseudorandom noise may be transmitted to the receiver out of channel. In other embodiments, the pseudorandom noise may be generated by a pseudorandom noise generator 132 configured to produce the same pseudorandom noise as the pseudorandom noise generator 112.

At step 556, the receiver 130 synchronizes the received acoustic signal with the pseudorandom noise signal. As described previously, in some preferred embodiments the PRN signal is selected to have a low autocorrelation. Those having ordinary skill in the art will understand that, while a low autocorrelation can provide a high signal-to-noise ratio, it can necessitate a precise timing alignment between received acoustic signal and the PRN signal in order to recover the original data signal 111.

In some embodiments, the synchronization at step 556 includes an acquisition phase and a tracking phase. The acquisition phase can include using a non-coherent linear search to identify an initial alignment between the received acoustic signal and the PRN signal. In a non-coherent linear search, the receiver 130 determines the alignment using a “guess and check” method. That is, the receiver 130 selects an estimated alignment and performs further processing based on the estimated alignment (e.g., demodulate the received acoustic signal using the estimated alignment to obtain an estimated data signal). The receiver 130 then tests the estimated data signal for various expected criteria (e.g. center frequency, bandwidth, etc.). In the case that the estimated data signal does not satisfy the expected criteria, the receiver 130 selects a new estimated alignment and obtains a corresponding new estimated data signal. The receiver 130 can continue to select different estimated alignments until the estimated data signal satisfies the expected criteria. Embodiments of the present invention may of course incorporate any other suitable method of synchronization acquisition understood by one having ordinary skill in the art (e.g., side channel or out of channel transmissions, synchronizing the transmitter 110 and receiver 130 beforehand, etc.)

The tracking phase can include using a delay-locked loop to maintain the timing alignment between the received acoustic signal and the PRN signal. In some embodiments, timing means in the transmitter 110 and receiver 130 may be at slightly different frequencies due to practical limitations. Over time, a slight discrepancy between the frequencies of the transmitter 110 and the receiver 130 may have a negative impact on the alignment between the received acoustic signal and the PRN signal. For example, if the received acoustic signal and the PRN signal are initially in perfect alignment, but the frequency of the transmitter 110 is just 0.1% faster than the frequency of the receiver 130, the signals may be out of alignment after less than 128 bytes have been transmitted. Using a delay-locked loop, the receiver 130 can compensate for the slight discrepancies between the frequencies of the transmitter 110 and the receiver 130. In some embodiments, this includes demodulating the received acoustic signal by the PRN signal assuming that the frequency of the receiver 130 is faster than the frequency of the transmitter 110 by a first amount Δ₁, and demodulating the received acoustic signal by the PRN signal assuming that the frequency of the receiver 130 is slower than the frequency of the transmitter 110 by a second amount Δ₂. The receiver 130 adjusts the amounts Δ₁, and Δ₂ so that the results of the demodulations are the same, thus maintaining a lock on the correct frequency matched to the frequency of the transmitter 110. Embodiments of the present invention may of course incorporate any other suitable method of synchronization tracking understood by one having ordinary skill in the art (e.g., side channel or out of channel transmissions, a taudither loop, etc.)

At step 558, the DSS demodulator uses the pseudorandom noise to demodulate the received acoustic signal, according to the synchronization performed in step 556, in order to obtain a data signal 131 (e.g., the original input signal 111).

In some embodiments, the process 500 and the process 550 may occur concurrently. In other embodiments, some or all of steps 554, 556, and 558 may occur after the transmitter 110 has completed transmitting the DSSS signal (i.e., after step 512 is complete) and may also occur after the receiver 120 has finished receiving return signals (i.e., after step 552 is complete).

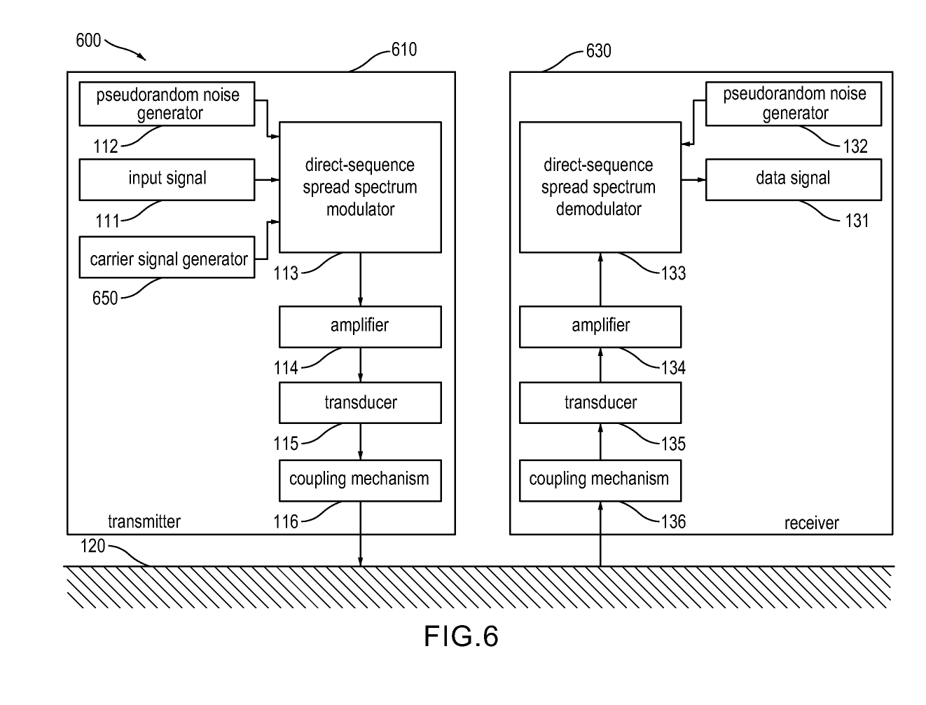

FIG. 6 illustrates a system 600 system for performing communication using acoustic signals according to aspects of the present invention. As illustrated in FIG. 6, the transmitter 610 can include a carrier signal. A carrier frequency is generated at the carrier signal generator 650 and used by the DSSS modulator to modulate the input signal 111 and pseudorandom noise signal. The carrier signal can be selected to match the capabilities of transmitter 610 and the receiver 630, or may be selected based upon the characteristics of the transmission medium 120. In some embodiments where the transmission medium 120 is, for example, the ground, the carrier signal may be selected to have a bandwidth range between at least 0.1 Hz to 1,000 Hz. In the receiver 630, the DSSS demodulator 133 is configured to demodulate the acoustic signal according to the carrier signal and the pseudorandom noise signal.

In some embodiments of the invention, a plurality of receivers (e.g., receivers 130, 230, or 620) can be utilized to receive transmissions from a single transmitter (e.g., a transmitter 110, 210, or 610). Each receiver uses the pseudorandom noise matched to that of the transmitter to recover the input signal for each transmitter receiver pair.

Pursuant to yet another embodiment of the invention, a plurality of transmitters (e.g., transmitters 130, 230, or 620) and a plurality of receivers (e.g., receivers 110, 210, or 610) can be utilized. Each transmitter is assigned a different pseudorandom noise sequence. The PRN sequences are selected to have low cross correlation, and therefore to provide low interference between the transmitted signals. The transmitters can transmit simultaneously, in which case each receiver receives the sum of acoustic signals from all active transmitters. Each demodulator of the receivers uses the PRN sequence matched to each transmitter to provide the input data for each transmitter receiver pair. By using multiple transmitters simultaneously, extended and redundant paths of communication can be provided.

### Example

An embodiment of the above described acoustic communication systems and methods was used to communicate a signal over a distance of approximately 10 meters through a transmission medium comprised primarily of moist topsoil. The embodiment used to perform the seismic survey described comprised an AudiSource Amp5.3 amplifier coupled to a Clark Synthesis TST429 Platinum transducer, GeoSpace GS-100 geophones, an IOTech Personal DAQ 3001, and a Dell Latitude D620 laptop computer. The transmitter is a commercially available amplifier and a low-power audio transducer, and the receiver is a commercial single-axis geophone. The transmitter and laptop were powered by a Black and Decker PI750AB power inverter plugged into the field vehicle. The transmitter was coupled to the ground via a small steel stake hand driven with a hammer, and the single geophone was moved to measured offsets.

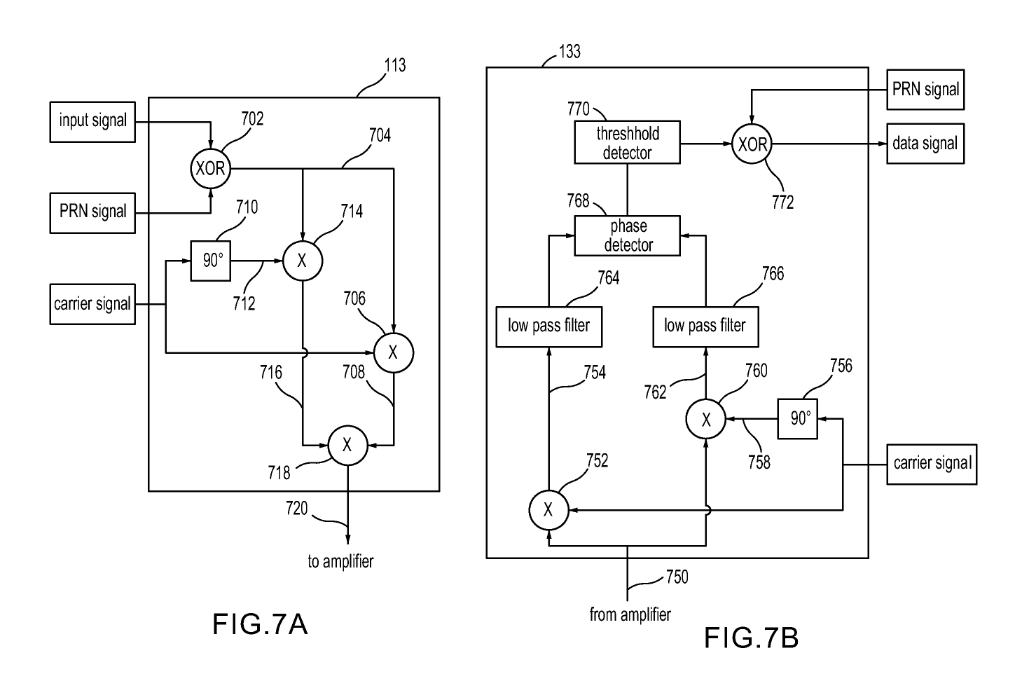

FIGS. 7A and 7B illustrate respectively the DSSS modulator 113 and DSSS demodulator 133 of this example embodiment. As illustrated in FIGS. 7A and 7B, this example embodiment implements binary phase-shift keying (“BPSK”) coherent modulation in a quadrature phase shift keying (“QPSK”) system.

As illustrated in FIG. 7A, the DSSS modulator 113 of the transmitter 110 combines the input signal with a PRN signal using an exclusive-or (“XOR”) operator 702 to generate an XOR output signal 704. The DSSS modulator 113 then uses the XOR output signal 704 to phase-modulate the carrier signal via a phase modulator 706 to generate an in-phase BPSK modulated signal 708. The DSSS modulator also uses a 90-degree phase shifter 710 to generate a quadrature version of the carrier signal 712, and uses the XOR output signal 704 to phase-modulate the quadrature version of the carrier signal 712 via another phase modulator 714 to generate a quadrature BPSK modulated signal 716. The DSSS modulator 113 then combines the in-phase BPSK modulated signal 708 with the quadrature BPSK modulated signal 716 using a summing operator 718 to generate the DSSS BPSK/QPSK modulated signal 720 for transmission to the amplifier and/or transducer.

As illustrated in FIG. 7B, the DSSS demodulator 133 of the receiver 130 uses a copy of the carrier signal to perform BPSK demodulation (e.g., using a BPSK demodulator 752) on the received acoustic signal (e.g., received from the amplifier) to generate a first demodulated signal 754. The DSSS demodulator 133 also uses a 90-degree phase shifter 756 to generate a quadrature version of the carrier signal 758, and uses the quadrature version of the carrier signal 758 to perform BPSK demodulation (e.g., using another BPSK demodulator 760) on the received acoustic signal to generate a second demodulated signal 762. In some embodiments, the DSSS demodulator 133 respectively applies low pass filters 764, 766 to the first and the second demodulated signals 754, 762. The DSSS demodulator 133 then detects the phase difference between the first and the second demodulated signals 754, 762 and uses a threshold detector 770 to recover the spread signal (i.e., the PRN signal combined with the data signal). Finally, the DSSS demodulator 133 combines the spread signal with a copy of the PRN signal using an XOR operator 772 to recover the data signal.

As will be understood by one having ordinary skill in the art, in some embodiments QPSK can be used to transmit multiple bits in the same timeframe by allowing bit n of the spread sequence to phase modulate the in-phase carrier signal, while bit n+1 of the spread signal to modulate the quadrature version of the carrier signal.

Similarly, in some embodiments quadrature amplitude modulation (“QAM”) can be used to transmit multiple bits in the same timeframe by allowing more than two bits to modulate the in-phase and quadrature versions of the carrier signal. For example, in 4-QAM bits n and n+1 can be converted to one of four discrete values (corresponding to bit patterns 00, 01, 10, 11) to modulate the in-phase carrier signal, and similarly bits n+2 and n+3 can modulate the quadrature version of the carrier signal. As will be understood by one having ordinary skill in the art, the number of discrete values used to modulate the carrier signal may be selected based on factors such as the amount of ambient acoustic noise, the amount of signal attenuation between the transmitter 110 and the receiver 130, the precision of the receiver 130, the amount of error correction available for the receiver 130, etc.

As will be understood by one having ordinary skill in the art, in some embodiments the above-described XOR operators in the DSSS modulator 113 and the DSSS modulator 133 can be replaced by XNOR operators (i.e., the logical inverse of XOR operators).

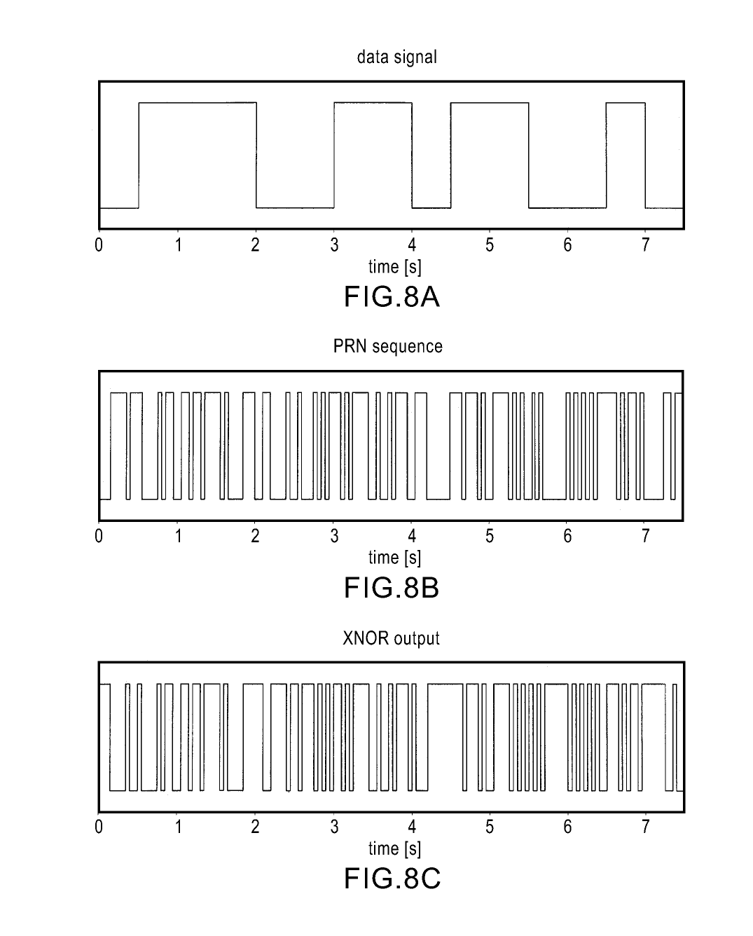

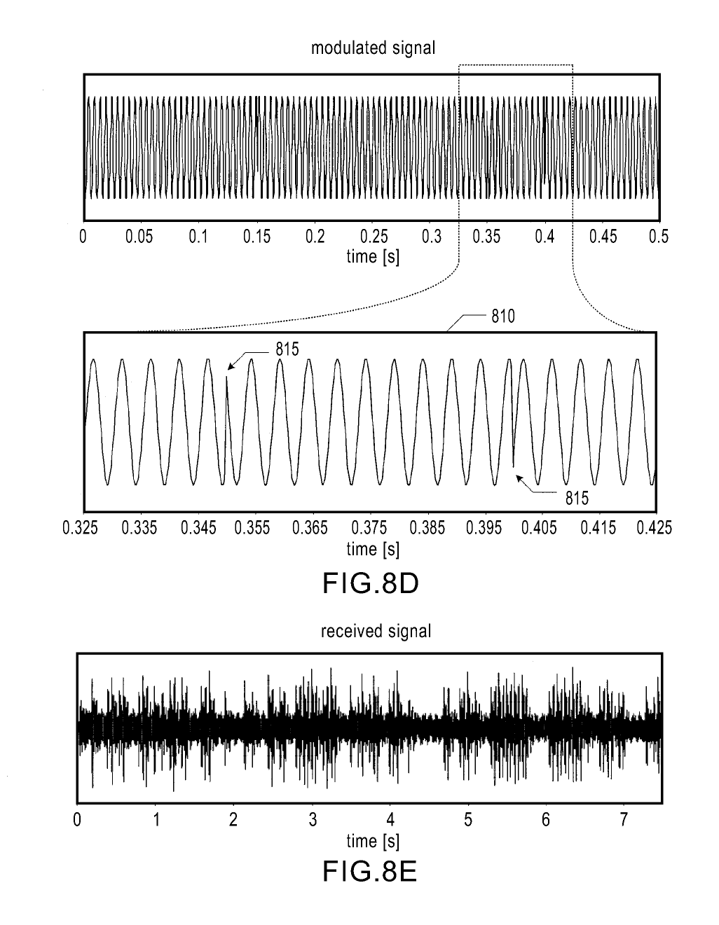

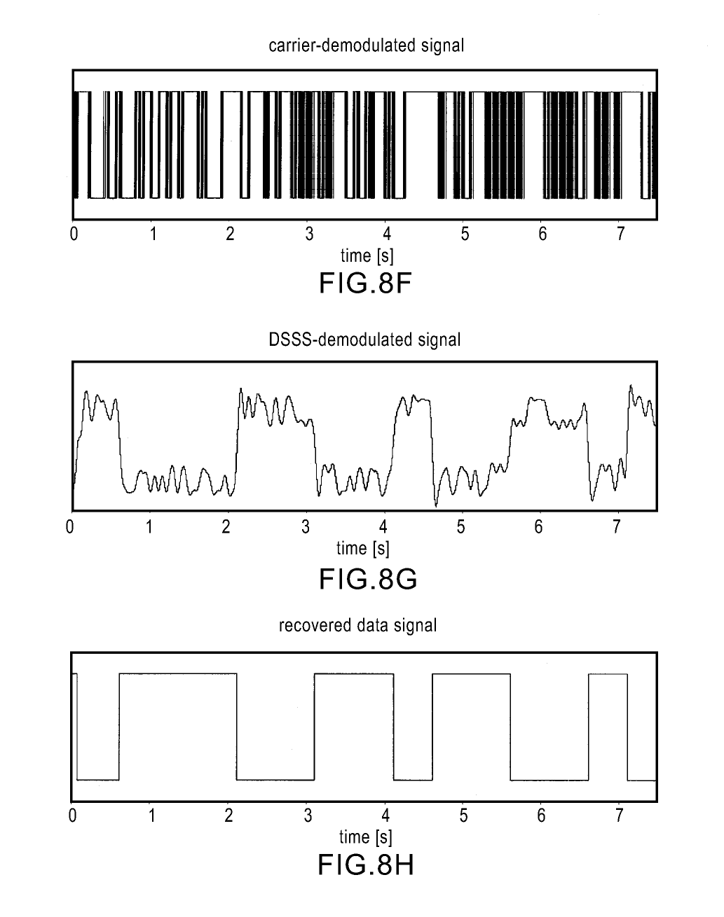

FIGS. 8A through 8H show a field record of generated, transmitted, and processed signals made using a 200 Hz carrier signal (e.g., from a carrier signal generator 650) modulated by a 2 bit-per-second digital data signal (i.e., input signal 111) and a 40 chips-per-second Gold code (i.e., a PRN sequence).

FIG. 8A illustrates a sample data signal, FIG. 8B illustrates a sample PRN sequence, and FIG. 8C illustrates the result of performing an XNOR operation between the data signal and the PRN signal (e.g., an XNOR output signal).

FIG. 8D illustrates a portion of a carrier signal modulated by the XNOR output signal using BPSK modulation (e.g., in-phase BPSK modulated signal 708). Inset 810 shows a portion of this signal in greater detail, illustrating phase shifts 815. As described above, in some embodiments this signal may be transmitted to the amplifier directly. In other embodiments, it may be combined with one or more additional signals (e.g., a quadrature BPSK modulated signal 716) before it is transmitted to the amplifier.

FIG. 8E illustrates an acoustic signal received, e.g., from the ground, by a receiver 130.

FIG. 8F illustrates a recovered spread signal, e.g., a received acoustic signal that has been demodulated by the carrier signal and subjected to a thresholding processing.

FIG. 8G illustrates a preliminary recovered data signal (e.g., the signal that is produced by performing DSSS demodulation on the received acoustic signal as described above).

FIG. 8H illustrates the recovered data signal that results from threshold processing on the preliminary recovered data signal. A comparison of FIGS. 8A and 8H illustrates a small time shift in the recovered signal that may arise from filtering processes in some embodiments. These time shifts can be addressed using conventional methods well known in the art.

Although the term “ground” has been used above to identify the medium in which the acoustic wave is propagated, the medium can actually be any medium through which an acoustic signal can be transmitted. By way of example only, in addition to the ground, the medium can also be other solids such as rocks, buildings, other structures, concrete, metal, and wood, as well as water and other liquids. It is to be understood that the medium can also contain air or gas pockets.

While various embodiments of the present invention have been described above, it should be understood that they have been presented by way of example only, and not limitation. Thus, the breadth and scope of the present invention should not be limited by any of the above described exemplary embodiments. Moreover, any combination of the above-described elements in all possible variations thereof is encompassed by the invention unless otherwise indicated herein or otherwise clearly contradicted by context.

1. A method of communicating using acoustic signals, comprising the steps of:
generating a pseudorandom noise signal;
modulating an input signal by said pseudorandom noise signal, thereby generating a direct-sequence spread spectrum signal;
generating in a transmission medium an acoustic wave corresponding to said direct-sequence spread spectrum signal.

2. The method of claim 1, wherein said step of generating a pseudorandom noise signal comprises generating a pseudorandom bit sequence.

3. The method of claim 2, wherein said step of generating a direct-sequence spread spectrum signal further comprises processing the pseudorandom bit sequence by at least one of bandwidth limiting and linear modulation.

4. The method of claim 1, wherein said step of generating an acoustic wave comprises:
converting said direct sequence spread spectrum signal into at least one of mechanical motion, air pressure, or fluid pressure, and
transmitting said converted signal into said transmission medium.

5. The method of claim 1, wherein generating an acoustic wave comprises at least one of embedding a transducer in said transmission medium and attaching a transducer to as object that is at least partially embedded in said transmission medium.

6. The method of claim 1, wherein said transmission medium comprises at least one of ground, a water table, bedrock, outcrops, and buildings.

7. The method of claim 1, wherein
the step of generating a pseudorandom noise signal further comprises generating a plurality of pseudorandom noise signals,
the step of modulating an input signal further comprises modulating a plurality of input signals respectively by said plurality of said pseudorandom noise signals, thereby generating a plurality of direct-sequence spread spectrum signals, and
the step of generating an acoustic further comprises simultaneously generating a plurality of acoustic waves, each of said plurality of acoustic waves respectively corresponding to each of said plurality of direct-sequence spread spectrum signals.

8. A method of communication using acoustic signals, comprising the steps of:
receiving an acoustic signal from a transmission medium;
obtaining a pseudorandom noise signal; and
demodulating said acoustic signal by said pseudorandom noise signal, thereby obtaining a data signal.

9. The method of claim 8, wherein said step of obtaining a pseudorandom noise signal comprises generating a pseudorandom bit sequence.

10. The method of claim 8, wherein said step of demodulating said acoustic signal comprises matching a phase of said acoustic signal with a phase of said pseudorandom noise signal.

11. The method of claim 8, wherein said step of receiving an acoustic signal from a transmission medium further comprises utilizing a transducer to convert at least one of mechanical motion, air pressure, or fluid pressure to an electrical signal.

12. The method of claim 8, wherein receiving an acoustic signal comprises at least one of embedding a transducer in said transmission medium and attaching a transducer to as object that is at least partially embedded in said transmission medium.

13. The method of claim 8, wherein
the step of obtaining a pseudorandom noise signal further comprises obtaining a plurality of pseudorandom noise signals, and
the step of demodulating said acoustic signal further comprises demodulating said acoustic signal by said plurality of pseudorandom noise signals, thereby obtaining a plurality of data signals.

14. A system for communicating using acoustic signals, comprising:
a noise generator configured to generate a pseudorandom noise signal;
a signal modulator configured to modulate an input signal by said pseudorandom noise signal, thereby generating a direct-sequence spread spectrum signal;
a transmit transducer configured to receive said direct-sequence spread spectrum signal, mechanically couple said direct-sequence spread spectrum signal to a transmission medium, and generate in the transmission medium an acoustic wave corresponding to said direct-sequence spread spectrum signal;
a receive transducer configured to receive said acoustic signal from said transmission medium generated by interaction between said acoustic wave and the transmission medium and convert said acoustic signal to electronic signals; and
a signal demodulator configured to receive from said receive transducer said electronic signal and demodulate said electronic signal by said pseudorandom noise signal, thereby obtaining said data signal.

15. The system of claim 14, wherein said noise generator is configured to generate a sequence of pseudorandom bits.

16. The system of claim 15, wherein said noise generator is configured to process said sequence of pseudorandom bits by at least one of bandwidth limiting and linear modulation.

17. The system of claim 14, wherein said transmit transducer is configured to mechanically couple the direct-sequence spread spectrum signal to the transmission medium using at least one of mechanical motion, air pressure, and fluid pressure.

18. The system of claim 17, wherein said transmit transducer comprises a coupling mechanism configured to transmit the air pressure or fluid pressure to the transmission medium.

19. The system of claim 18, wherein said coupling mechanism comprises an object at least partially embedded in the transmission medium.

20. The system of claim 14, wherein a single transducer is configured as said transmit transducer and as said receive transducer.

21. A computer program product for communicating using acoustic signals, said computer program product comprising a digital storage medium and a set of machine readable instructions stored on said digital storage medium, wherein said instructions are executable by a computer to:
generate a pseudorandom noise signal;
modulate an input signal by said pseudorandom noise signal, thereby generating a direct-sequence spread spectrum signal; and
transmit said direct-sequence spread spectrum signal to a transmit transducer mechanically coupled to a transmission medium.

22. The computer program product of claim 21, wherein generating a pseudorandom noise signal comprises generating a pseudorandom bit sequence.

23. The computer program product of claim 22, wherein generating a direct-sequence spread spectrum signal further comprises processing the pseudorandom bit sequence by at least one of bandwidth limiting and linear modulation.

24. The computer program product of claim 21, wherein said transmit transducer is configured to:
convert said direct sequence spread spectrum signal into at least one of mechanical motion, air pressure, or fluid pressure, and
transmit said converted signal into said target medium.

25. The computer program product of claim 21, wherein said target medium comprises at least one of ground, a water table, bedrock, outcrops, and buildings.

26. The computer program product of claim 21, wherein
generating a pseudorandom noise signal comprises generating a plurality of pseudorandom noise signals,
modulating an input signal further comprises modulating a plurality of input signals respectively by said plurality of said pseudorandom noise signals, thereby generating a plurality of direct-sequence spread spectrum signals, and
transmitting said direct-sequence spread spectrum signal further comprises transmitting said plurality of direct-sequence spread spectrum signals to one or more transmit transducers.

27. A computer program product for communicating using acoustic signals, said computer program product comprising a digital storage medium and a set of machine readable instructions stored on said digital storage medium, wherein said instructions are executable by a computer to:
receive from a receive transducer mechanically coupled to a transmission medium an acoustic signal;
obtain a pseudorandom noise signal; and
demodulate said acoustic signal by said pseudorandom noise signal, thereby obtaining a data signal.

28. The computer program product of claim 27, wherein obtaining a pseudorandom noise signal comprises generating a pseudorandom bit sequence.

29. The computer program product of claim 27, wherein demodulating said acoustic signal comprises matching a phase of said acoustic signal with a phase of said pseudorandom noise signal.

30. The computer program product of claim 27, wherein said receive transducer is configured to convert at least one of mechanical motion, air pressure, or fluid pressure to an electrical signal.

31. The computer program product of claim 8, wherein
obtaining a pseudorandom noise signal further comprises obtaining a plurality of pseudorandom noise signals, and
demodulating said acoustic signal further comprises demodulating said acoustic signal by said plurality of pseudorandom noise signals, thereby obtaining a plurality of data signals.
